(19) United States
(12) Patent Application Publication
(10) Pub. No.: US 2024/0190000 A1
(43) Pub. Date: Jun. 13, 2024

(54) ACTION CONTROL DEVICE, ACTION CONTROL METHOD, AND RECORDING MEDIUM

(71) Applicant: CASIO COMPUTER CO., LTD., Tokyo (JP)

(72) Inventors: Kouki MAYUZUMI, Tokyo (JP); Erina ICHIKAWA, Tokyo (JP); Hirokazu HASEGAWA, Tokyo (JP); Miyuki URANO, Tokyo (JP)

(73) Assignee: CASIO COMPUTER CO., LTD., Tokyo (JP)

(21) Appl. No.: 18/513,561

(22) Filed: Nov. 19, 2023

(30) Foreign Application Priority Data
Dec. 8, 2022 (JP) 2022-196457

(51) Int. Cl. B25J 9/16; B25J 11/00

(52) U.S. Cl. CPC B25J 9/1664; B25J 11/003

(57) ABSTRACT

A controller of an action control device that controls an action of a controlled device, wherein the controller controls the action of the controlled device using set control data that is set in advance in correspondence with a pseudo-emotion and random control data that is randomly generated in accordance with the pseudo-emotion.

### CROSS-REFERENCE TO RELATED APPLICATIONS

This application claims the benefit of Japanese Patent Application No. 2022-196457, filed on Dec. 8, 2022, the entire disclosure of which is incorporated by reference herein.

### FIELD OF THE INVENTION

The present disclosure relates generally to an action control device, an action control method, and a recording medium.

### BACKGROUND OF THE INVENTION

Robots, for example, the robot disclosed in Unexamined Japanese Patent Application Publication No. 2002-239960, are known in the art. This conventional robot is a dog-like robot, includes a torso, a head, legs, and the like, and is capable of executing various lifelike actions by driving the head and the legs relative to the torso.

### SUMMARY OF THE INVENTION

One aspect of an action control device according to the present disclosure is
an action control device including a controller that controls an action of a controlled device, wherein
the controller
controls the action of the controlled device using set control data that is set in advance in correspondence with a pseudo-emotion and random control data that is randomly generated in accordance with the pseudo-emotion.

### BRIEF DESCRIPTION OF DRAWINGS

A more complete understanding of this application can be obtained when the following detailed description is considered in conjunction with the following drawings, in which:

FIG. 1 is a drawing illustrating the appearance of a robot according to Embodiment 1;

FIG. 2 is a cross-sectional view of the robot according to Embodiment 1, viewed from a side surface;

FIG. 3 is a drawing for explaining a housing of the robot according to Embodiment 1;

FIG. 4 is a block diagram illustrating the functional configuration of the robot according to Embodiment 1;

FIG. 5 is a drawing for explaining an example of an emotion map according to Embodiment 1;

FIG. 6 is a drawing for explaining an example of a control content table according to Embodiment 1;

FIG. 7 is a flowchart of action control processing according to Embodiment 1;

FIG. 8 is a flowchart of spontaneous action processing according to Embodiment 1;

FIG. 9 is a drawing illustrating an example of a 3D map for setting an up-down intensity parameter according to Embodiment 1;

FIG. 10 is a drawing illustrating an example of a 3D map for setting a left-right intensity parameter according to Embodiment 1;

FIG. 11 is a drawing illustrating an example of a 3D map for setting an up-down amplitude parameter according to Embodiment 1;

FIG. 12 is a drawing illustrating an example of a 3D map for setting a left-right amplitude parameter according to Embodiment 1;

FIG. 13 is a drawing illustrating an example of a 3D map for setting an offset parameter according to Embodiment 1;

FIG. 14 is a drawing for explaining regions in which specific action parameters are set according to Embodiment 1;

FIG. 15 is a flowchart of a trembling action generating process according to Embodiment 1;

FIG. 16 is a drawing illustrating an example of a waveform of action control data generated by the trembling action generating process according to Embodiment 1;

FIG. 17 is a flowchart of a grooming action generating process according to Embodiment 1;

FIG. 18 is a drawing illustrating an example of a waveform of action control data generated by the grooming action generating process according to Embodiment 1;

FIG. 19 is a flowchart of a gratification action generating process according to Embodiment 1;

FIG. 20 is a drawing illustrating an example of a jump motion waveform to be combined in the gratification action generating process according to Embodiment 1;

FIG. 21 is a drawing illustrating an example of a waveform of action control data generated by the gratification action generating process according to Embodiment 1;

FIG. 22 is a flowchart of an emotional action generating process according to Embodiment 2;

FIG. 23 is a drawing illustrating an example of the manner in which a combining ratio of a random waveform of action control data changes in accordance with a growth days count in Embodiment 3; and

FIG. 24 is a block diagram illustrating the functional configuration of an action control device and a robot according to a modified example.

### DETAILED DESCRIPTION OF THE INVENTION

Hereinafter, embodiments of the present disclosure are described while referencing the drawings. Note that, in the drawings, identical or corresponding components are denoted with the same reference numerals.

### Embodiment 1

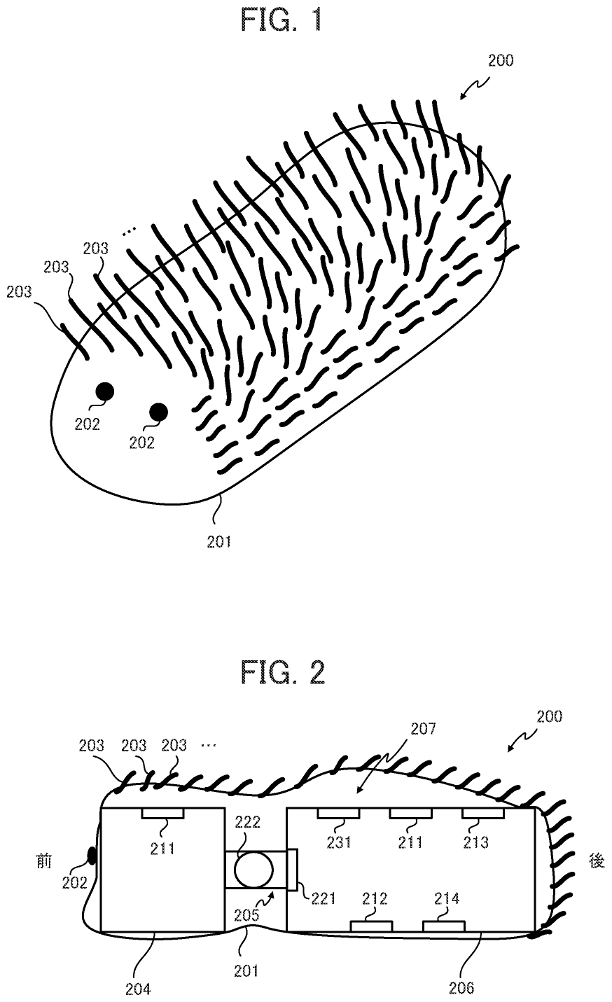

An embodiment in which an action control device according to Embodiment 1 is applied to a robot 200 illustrated in FIG. 1 is described while referencing the drawings. As illustrated in FIG. 1, the robot 200 according to the embodiment is a pet robot that resembles a small animal. The robot 200 is covered with an exterior 201 provided with bushy fur 203 and decorative parts 202 resembling eyes. A housing 207 of the robot 200 is accommodated in the exterior 201. As illustrated in FIG. 2, the housing 207 of the robot 200 includes a head 204, a coupler 205, and a torso 206. The head 204 and the torso 206 are coupled by the coupler 205.

Regarding the torso 206, as illustrated in FIG. 2, a twist motor 221 is provided at a front end of the torso 206, and the head 204 is coupled to the front end of the torso 206 via the coupler 205. The coupler 205 is provided with a vertical motor 222. Note that, in FIG. 2, the twist motor 221 is provided on the torso 206, but may be provided on the coupler 205 or on the head 204.

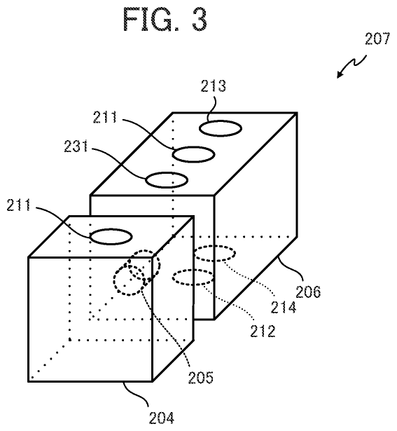

The coupler 205 couples the torso 206 and the head 204 so as to enable rotation (by the twist motor 221) around a first rotational axis that passes through the coupler 205 and extends in a front-back direction of the torso 206. The twist motor 221 rotates the head 204, with respect to the torso 206, clockwise (right rotation) within a forward rotation angle range around the first rotational axis (forward rotation), counter-clockwise (left rotation) within a reverse rotation angle range around the first rotational axis (reverse rotation), and the like. Note that, in this description, the term “clockwise” refers to clockwise when viewing the direction of the head 204 from the torso 206. A maximum value of the angle of twist rotation to the right (right rotation) or the left (left rotation) can be set as desired, and the angle of the head 204 in a state, as illustrated in FIG. 3, in which the head 204 is not twisted to the right or the left is referred to as a “twist reference angle.”

The coupler 205 couples the torso 206 and the head 204 so as to enable rotation (by the vertical motor 222) around a second rotational axis that passes through the coupler 205 and extends in a width direction of the torso 206. The vertical motor 222 rotates the head 204 upward (forward rotation) within a forward rotation angle range around the second rotational axis, downward (reverse rotation) within a reverse rotation angle range around the second rotational axis, and the like. A maximum value of the angle of rotation upward or downward can be set as desired, and the angle of the head 204 in a state, as illustrated in FIG. 3, in which the head 204 is not rotated upward or downward is referred to as a “vertical reference angle.” Note that, in FIG. 2, an example is illustrated in which the first rotational axis and the second rotational axis are orthogonal to each other, but a configuration is possible in which the first and second rotational axes are not orthogonal to each other.

As illustrated in FIG. 2, the robot 200 includes a touch sensor 211 on the head 204. The touch sensor 211 can detect petting or striking of the head 204 by a user. The robot 200 also includes the touch sensor 211 on the torso 206. The touch sensor 211 can detect petting or striking of the torso 206 by the user.

The robot 200 includes an acceleration sensor 212 on the torso 206. The acceleration sensor 212 can detect an attitude (orientation) of the robot 200, and can detect being picked up, the orientation being changed, being thrown, and the like by the user. The robot 200 includes a gyrosensor 214 on the torso 206. The gyrosensor 214 can detect vibrating, rolling, rotating, and the like of the robot 200.

The robot 200 includes a microphone 213 on the torso 206. The microphone 213 can detect external sounds. Furthermore, the robot 200 includes a speaker 231 on the torso 206. The speaker 231 can be used to emit a sound (sound effect) of the robot 200.

Note that, in the present embodiment, the acceleration sensor 212, the gyrosensor 214, the microphone 213, and the speaker 231 are provided on the torso 206, but a configuration is possible in which all or a portion of these components are provided on the head 204. Note that a configuration is possible in which, in addition to the acceleration sensor 212, the gyrosensor 214, the microphone 213, and the speaker 231 provided on the torso 206, all or a portion of these components are also provided on the head 204. The touch sensor 211 is provided on each of the head 204 and the torso 206, but a configuration is possible in which the touch sensor 211 is provided on only one of the head 204 and the torso 206. Moreover, a configuration is possible in which a plurality of any of these components is provided.

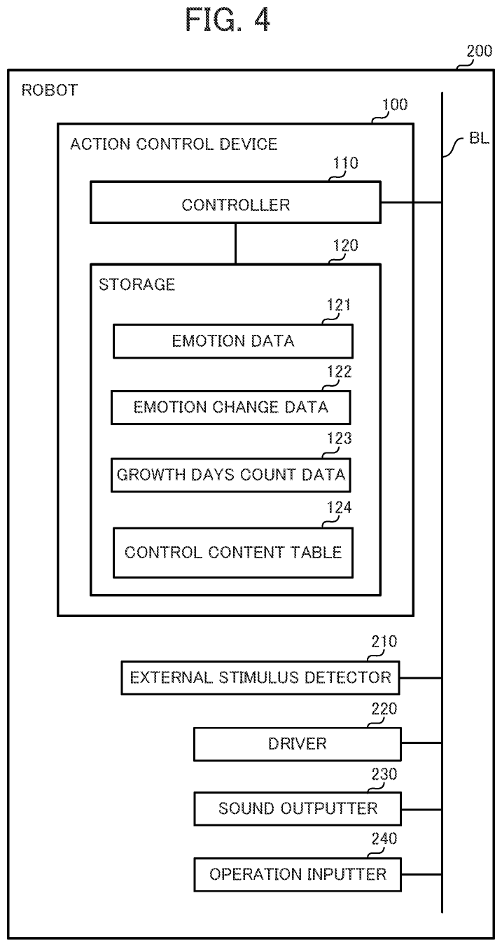

Next, the functional configuration of the robot 200 is described. As illustrated in FIG. 4, the robot 200 includes an action control device 100, an external stimulus detector 210, a driver 220, a sound outputter 230, and an operation inputter 240. Moreover, the action control device 100 includes a controller 110 and a storage 120. In FIG. 4, the action control device 100, and the external stimulus detector 210, the driver 220, the sound outputter 230, and the operation inputter 240 are connected to each other via a bus line BL, but this is merely an example. A configuration is possible in which the action control device 100, and the external stimulus detector 210, the driver 220, the sound outputter 230, and the operation inputter 240 are connected by a wired interface such as a universal serial bus (USB) cable or the like, or by a wireless interface such as Bluetooth (registered trademark) or the like. Additionally, a configuration is possible in which the controller 110 and the storage 120 are connected via the bus line BL.

The action control device 100 controls, by the controller 110 and the storage 120, actions of the robot 200. Note that the robot 200 is a device that is controlled by the action control device 100 and, as such, is also called a “controlled device.”

In one example, the controller 110 is configured from a central processing unit (CPU) or the like, and executes various processings described later using programs stored in the storage 120. Note that the controller 110 is compatible with multithreading functionality, in which a plurality of processings are executed in parallel. As such, the controller 110 can execute the various processings described below in parallel. Additionally, the controller 110 is provided with a clock function and a timer function, and can measure the date and time, and the like.

Additionally, in spontaneous action processing described later, the controller 110 functions as a random waveform generator that uses Perlin noise. This random waveform generator generates waveforms (random waveforms) for which the amplitude is random and the frequency is determined on the basis of an input parameter.

The storage 120 is configured from read-only memory (ROM), flash memory, random access memory (RAM), or the like. Programs to be executed by the CPU of the controller 110, and data needed in advance to execute these programs are stored in the ROM. The flash memory is writable non-volatile memory, and stores data that is desired to be retained even after the power is turned OFF. Data that is created or modified during the execution of the programs is stored in the RAM. In one example, the storage 120 stores emotion data 121, emotion change data 122, growth days count data 123, a control content table 124, and the like, all described hereinafter.

The external stimulus detector 210 includes the touch sensor 211, the acceleration sensor 212, the gyrosensor 214, and the microphone 213 described above. The controller 110 acquires, as a signal expressing an external stimulus acting on the robot 200, detection values (external stimulus data) detected by the various sensors of the external stimulus detector 210. Note that a configuration is possible in which the external stimulus detector 210 includes sensors other than the touch sensor 211, the acceleration sensor 212, the gyrosensor 214, and the microphone 213. The types of external stimuli acquirable by the controller 110 can be increased by increasing the types of sensors of the external stimulus detector 210.

The touch sensor 211 detects contacting by some sort of object. The touch sensor 211 is configured from a pressure sensor or a capacitance sensor, for example. The controller 110 acquires a contact strength and/or a contact time on the basis of the detection values from the touch sensor 211 and, on the basis of these values, can detect an external stimulus such as that the robot 200 is being pet or being struck by the user, and the like (for example, see Unexamined Japanese Patent Application Publication No. 2019-217122). Note that a configuration is possible in which the controller 110 detects these external stimuli by a sensor other than the touch sensor 211 (for example, see Japanese Patent No. 6575637).

The acceleration sensor 212 detects acceleration in three axial directions, namely the front-back direction (X-axis direction), the width (left-right) direction (Y-axis direction), and the vertical direction (Z direction) of the torso 206 of the robot 200. The acceleration sensor 212 detects gravitational acceleration when the robot 200 is stopped and, as such, the controller 110 can detect a current attitude of the robot 200 on the basis of the gravitational acceleration detected by the acceleration sensor 212. Additionally, when, for example, the user picks up or throws the robot 200, the acceleration sensor 212 detects, in addition to the gravitational acceleration, acceleration caused by the movement of the robot 200. Accordingly, the controller 110 can detect the movement of the robot 200 by removing the gravitational acceleration component from the detection value detected by the acceleration sensor 212.

The gyrosensor 214 detects angular velocity of the three axes of the robot 200. The controller 110 can determine a rotation state of the robot 200 on the basis of the angular velocities of the three axes. Additionally, the controller 110 can determine a vibration state of the robot 200 on the basis of the maximum values of the angular velocities of the three axes.

The microphone 213 detects ambient sound of the robot 200. The controller 110 can, for example, detect, on the basis of a component of the sound detected by the microphone 213, that the user is speaking to the robot 200, that the user is clapping their hands, and the like.

The driver 220 includes the twist motor 221 and the vertical motor 222. The driver 220 is driven by the controller 110. As a result, the robot 200 can express actions such as, for example, lifting the head 204 up (rotating upward around the second rotational axis), twisting the head 204 sideways (twisting/rotating to the right or to the left around the first rotational axis), and the like. Motion data for driving the driver 220 in order to express these actions is recorded in a control content table 124, described later.

The sound outputter 230 includes the speaker 231, and sound is output from the speaker 231 as a result of sound data being input into the sound outputter 230 by the controller 110. For example, the robot 200 emits a pseudo-animal sound as a result of the controller 110 inputting animal sound data of the robot 200 into the sound outputter 230. This animal sound data is recorded as sound effect data in the control content table 124, described later.

In one example, the operation inputter 240 is configured from an operation button, a volume knob, or the like. The operation inputter 240 is an interface for receiving user operations such as, for example, turning the power ON/OFF, adjusting the volume of the output sound, and the like.

Next, of the data stored in the storage 120 of the action control device 100, the characteristic data of the present embodiment, namely, the emotion data 121, the emotion change data 122, the growth days count data 123, and the control content table 124 are described in order.

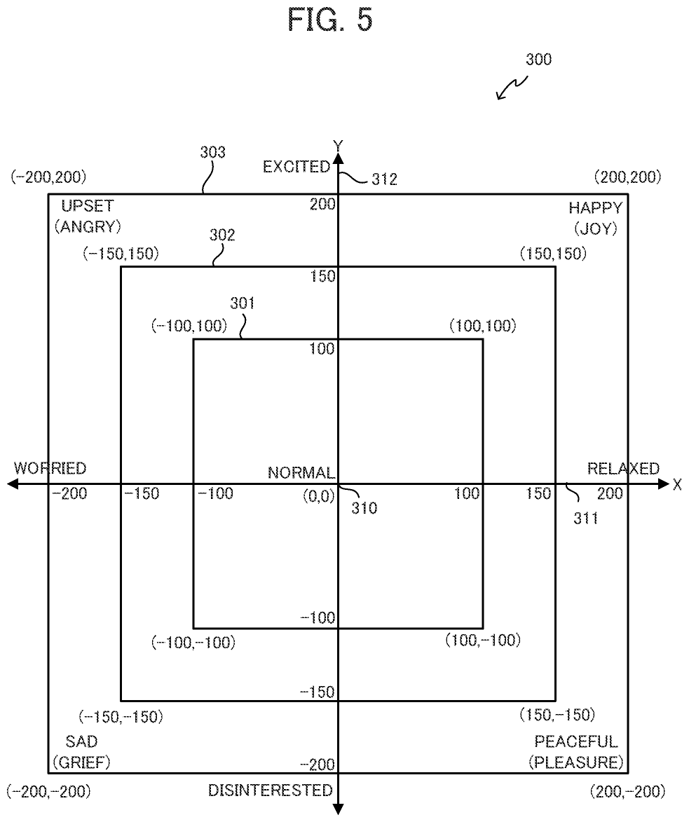

The emotion data 121 is data for imparting pseudo-emotions to the robot 200, and is data (X, Y) that represents coordinates on an emotion map 300. As illustrated in FIG. 5, the emotion map 300 is expressed by a two-dimensional coordinate system with a degree of relaxation (degree of worry) axis as an X axis 311, and a degree of excitement (degree of disinterest) axis as a Y axis 312. An origin 310 (0, 0) on the emotion map 300 represents an emotion when normal. Moreover, as the value of the X coordinate (X value) is positive and the absolute value thereof increases, emotions for which the degree of relaxation is high are expressed and, as the value of the Y coordinate (Y value) is positive and the absolute value thereof increases, emotions for which the degree of excitement is high are expressed. Additionally, as the X value is negative and the absolute value thereof increases, emotions for which the degree of worry is high are expressed and, as the Y value is negative and the absolute value thereof increases, emotions for which the degree of disinterest is high are expressed. Note that, in FIG. 5, the emotion map 300 is expressed as a two-dimensional coordinate system, but the number of dimensions of the emotion map 300 may be set as desired.

In the present embodiment, regarding the size of the emotion map 300 as the initial value, as illustrated by frame 301 of FIG. 5, a maximum value of both the X value and the Y value is 100 and a minimum value is −100. Moreover, during a first period, each time the pseudo growth days count of the robot 200 increases one day, the maximum value and the minimum value of the emotion map 300 both increase by two. Here, the first period is a period in which the robot 200 grows in a pseudo manner, and is, for example, a period of 50 days from a pseudo birth of the robot 200. Note that the pseudo birth of the robot 200 is the time of the first start up by the user of the robot 200 after shipping from the factory. When the growth days count is 25 days, as illustrated by frame 302 of FIG. 5, the maximum value of the X value and the Y value is 150 and the minimum value is −150. Moreover, when the first period elapses (in this example, 50 days), the pseudo growth of the robot 200 ends and, as illustrated in frame 303 of FIG. 5, the maximum value of the X value and the Y value is 200, the minimum value is −200, and the size of the emotion map 300 is fixed.

As illustrated in FIG. 5, the values (X, Y) of the emotion data 121 on the emotion map 300 correspond to emotions of joy, anger, grief, and pleasure. Specifically, the emotion of joy strengthens with proximity to (200, 200), the emotion of anger strengthens with proximity to (−200, 200), the emotion of grief strengthens with proximity to (−200, −200), and the emotion of pleasure strengthens with proximity to (200, −200).

The emotion change data 122 is data that sets an amount of change that each of an X value and a Y value of the emotion data 121 is increased or decreased. In the present embodiment, as emotion change data 122 corresponding to the X of the emotion data 121, DXP that increases the X value and DXM that decreases the X value are provided and, as emotion change data 122 corresponding to the Y value of the emotion data 121, DYP that increases the Y value and DYM that decreases the Y value are provided. Specifically, the emotion change data 122 includes the following four variables, and is data expressing degrees to which the pseudo-emotions of the robot 200 are changed.

DXP: Tendency to relax (tendency to change in the positive value direction of the X value on the emotion map)

DXM: Tendency to worry (tendency to change in the negative value direction of the X value on the emotion map)

DYP: Tendency to be excited (tendency to change in the positive value direction of the Y value on the emotion map)

DYM: Tendency to be disinterested (tendency to change in the negative value direction of the Y value on the emotion map)

In the present embodiment, an example is described in which the initial value of each of these variables is set to 10, and the value increases to a maximum of 20 by processing for learning the emotion change data 122 in action control processing, described later. Due to this learning processing, the emotion change data 122, that is, the degree of change of emotion changes and, as such, the robot 200 assumes various personalities in accordance with the manner in which the user interacts with the robot 200. That is, the personality of each individual robot 200 is formed differently on the basis of the manner in which the user interacts with the robot 200.

In the present embodiment, each piece of personality data (personality value) is derived by subtracting 10 from each piece of emotion change data 122. Specifically, a value obtained by subtracting 10 from DXP that expresses a tendency to be relaxed is set as a personality value (chipper), a value obtained by subtracting 10 from DXM that expresses a tendency to be worried is set as a personality value (shy), a value obtained by subtracting 10 from DYP that expresses a tendency to be excited is set as a personality value (active), and a value obtained by subtracting 10 from DYM that expresses a tendency to be disinterested is set as a personality value (spoiled).

The growth days count data 123 has an initial value of 1, and 1 is added for each passing day. The growth days count data 123 represents a pseudo growth days count (number of days from a pseudo birth) of the robot 200. Here, a period of the growth days count expressed by the growth days count data 123 is called a “second period.”

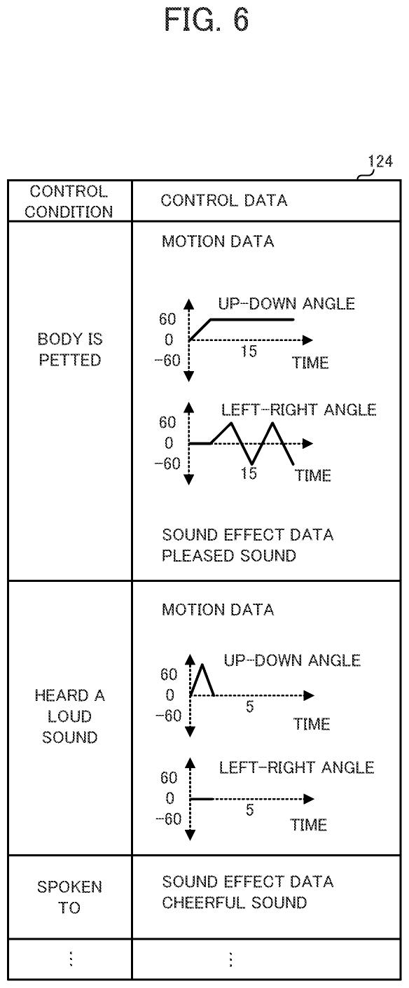

As illustrated in FIG. 6, control conditions and control data are associated and stored in the control content table 124. When a control condition is satisfied (for example, some sort of external stimulus is detected), the controller 110 controls the driver 220 and the sound outputter 230 on the basis of the corresponding control data (motion data for expressing an action by the driver 220, and sound effect data for outputting a sound effect from the sound outputter 230).

The motion data is sequence data expressing a rotational angle, for every elapsed time, of the vertical motor 222 and the twist motor 221 of the driver 220. In FIG. 6, this sequence data is expressed as a waveform of a graph that indicates the value of the rotational angle (degree) for every amount of time (step) (in the present embodiment, 1 step corresponds to 0.1 seconds). For example, when the body is petted, the controller 110 and the driver 220 are controlled so that, firstly (at 0 sec), the rotational angle (up-down angle) of the vertical motor 222 and the rotational angle (left-right angle) of the twist motor 221 are set to 0 degrees (vertical reference angle and twist reference angle), at 0.5 sec, the head 204 is raised so that the rotational angle of the vertical motor 222 becomes 60 degrees, and at 1 sec, the head 204 is twisted so that the rotational angle of the twist motor 221 becomes 60 degrees.

Regarding the sound effect data, to facilitate ease of understanding, text describing each piece of the sound effect data is included in FIG. 6, but in actuality, the sound effect data (for example, sampled sound data) described by the text itself is stored in the control content table 124 as the sound effect data.

Note that, in the control content table 124 illustrated in FIG. 6, control data is determined for every control condition, but a configuration is possible in which the control data is changed in accordance with emotion (expressed by the coordinates on the emotion map 300).

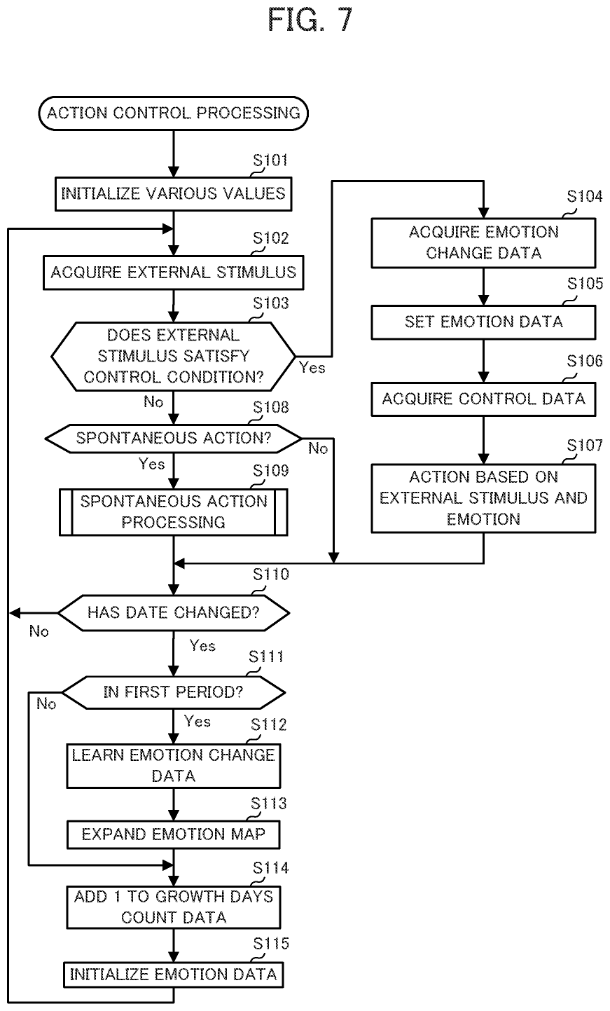

Next, the action control processing executed by the controller 110 of the action control device 100 is described while referencing the flowchart illustrated in FIG. 7. The action control processing is processing in which the action control device 100 controls the motions, sounds, and the like of the robot 200 on the basis of the detection values from the external stimulus detector 210 and, also, controls the robot 200 on a regular basis by automatically generating motion based on the emotion of the robot 200. The action control processing starts when the user turns ON the power of the robot 200.

Firstly, the controller 110 initializes the various types of data such as the emotion data 121, the emotion change data 122, the growth days count data 123, and the like (step S101). Note that, a configuration is possible in which, for the second and subsequent startups of the robot 200, the various values from when the power of the robot 200 was last turned OFF are set in step S101. This can be realized by the controller 110 storing the various data values in nonvolatile memory (flash memory or the like) of the storage 120 when an operation for turning the power OFF is performed the last time and, when the power is thereafter turned ON, setting the stored values as the various data values.

Next, the controller 110 acquires an external stimulus detected by the external stimulus detector 210 (step S102). Then, the controller 110 determines whether there is a control condition, among the control conditions defined in the control content table 124, that is satisfied by the external stimulus acquired in step S102 (step S103).

When a determination is made that any of the control conditions defined in the control content table 124 is satisfied by the acquired external stimulus (step S103; Yes), the controller 110 acquires the emotion change data 122 in accordance with the external stimulus acquired in step S102 (step S104). When, for example, petting of the head 204 is detected as the external stimulus, the robot 200 obtains a pseudo sense of relaxation and, as such, the controller 110 acquires DXP as the emotion change data 122 to be added to the X value of the emotion data 121.

Next, the controller 110 sets the emotion data 121 in accordance with the emotion change data 122 acquired in step S104 (step S105). When, for example, DXP is acquired as the emotion change data 122 in step S104, the controller 110 adds the DXP of the emotion change data 122 to the X value of the emotion data 121. However, in a case in which a value (X value, Y value) of the emotion data 121 exceeds the maximum value of the emotion map 300 when adding the emotion change data 122, that value of the emotion data 121 is set to the maximum value of the emotion map 300. In addition, in a case in which a value of the emotion data 121 is less than the minimum value of the emotion map 300 when subtracting the emotion change data 122, that value of the emotion data 121 is set to the minimum value of the emotion map 300.

In steps S104 and S105, any type of settings are possible for the type of emotion change data 122 acquired and the emotion data 121 set for each individual external stimulus. Examples are described below.

The head 204 is petted (relax): X=X+DXP

The head 204 is struck (worry): X=X−DXM

(these external stimuli can be detected by the touch sensor 211 of the head 204)

The torso 206 is petted (excite): Y=Y+DYP

The torso 206 is struck (disinterest): Y=Y−DYM

(these external stimuli can be detected by the touch sensor 211 of the torso 206)

Held with head upward (pleased): X=X+DXP, and Y=Y+DYP

Suspended with head downward (sad): X=X-DXM, and Y=Y−DYM

(these external stimuli can be detected by the touch sensor 211, the acceleration sensor 212, and the gyrosensor 214)

Spoken to in kind voice (peaceful): X=X+DXP, and Y=Y-DYM

Yelled at in loud voice (upset): X=X-DXM, and Y=Y+DYP

(these external stimuli can be detected by the microphone 213)

Next, controller 110 references the control content table 124 and acquires the control data corresponding to the control condition that is satisfied by the external stimulus acquired in step S102 (step S106).

Then, the controller 110 executes an action based on the control data acquired in step S106 and the emotion data 121 set in step S105 (step S107), and executes step S110. However, as in the control content table 124 illustrated in FIG. 6, when the control data does not change in accordance with the emotion data 121, in step S107, the controller 110 simply controls the driver 220 and the sound outputter 230 on the basis of the control data acquired in step S106.

Meanwhile, when, in step S103, a determination is made that none of the control conditions defined in the control content table 124 are satisfied by the acquired external stimulus (step S103; No), the controller 110 determines whether to perform a spontaneous action such as a breathing action or the like (step S108). Any method may be used as the method for determining whether to perform the spontaneous action and, in the present embodiment, it is assumed that the determination of step S108 is “Yes” for every spontaneous action cycle (for example, two seconds).

When a determination is made to not perform the spontaneous action (step S108; No), the controller 110 executes step S110. When a determination is made to perform the spontaneous action (step S108; Yes), the controller 110 executes spontaneous action processing (step S109), and executes step S110. The spontaneous action processing is processing for performing a breathing action, an emotion expression action, or the like (action generated on the basis of the emotion data 121), and details thereof are described later.

In step S110, the controller 110 uses the clock function to determine whether a date has changed. When a determination is made that the date has not changed (step S110; No), the controller 110 executes step S102.

When a determination is made that the date has changed (step S110; Yes), the controller 110 determines whether it is in a first period (step S111). When the first period is, for example, a period 50 days from the pseudo birth (for example, the first startup by the user after purchase) of the robot 200, the controller 110 determines that it is in the first period when the growth days count data 123 is 50 or less. When a determination is made that it is not in the first period (step S111; No), the controller 110 executes step S114.

When a determination is made that it is in the first period (step S111; Yes), the controller 110 performs learning of the emotion change data 122 (step S112). The learning of the emotion change data 122 is, specifically, processing for updating the emotion change data 122 by adding 1 to the DXP of the emotion change data 122 when the X value of the emotion data 121 is set to the maximum value of the emotion map 300 even once in step S105 of that day, adding 1 to the DYP of the emotion change data 122 when the Y value of the emotion data 121 is set to the maximum value of the emotion map 300 even once in step S105 of that day, adding 1 to the DXM of the emotion change data 122 when the X value of the emotion data 121 is set to the minimum value of the emotion map 300 even once in step S105 of that day, and adding 1 to the DYM of the emotion change data 122 when the Y value of the emotion data 121 is set to the minimum value of the emotion map 300 even once in step S105 of that day.

However, when the various values of the emotion change data 122 become exceedingly large, the amount of change of one time of the emotion data 121 becomes exceedingly large and, as such, the maximum value of the various values of the emotion change data 122 is set to 20, for example, and the various values are limited to that maximum value or less. Here, 1 is added to each piece of the emotion change data 122, but the value to be added is not limited to 1. For example, a configuration is possible in which a number of times at which the various values of the emotion data 121 are set to the maximum value or the minimum value of the emotion map 300 is counted and, when that number of times is great, the numerical value to be added to the emotion change data 122 is increased.

Next, the controller 110 expands the emotion map 300 (step S113). Expanding the emotion map 300 is, specifically, processing in which the controller 110 expands both the maximum value and the minimum value of emotion map 300 by 2. However, the numerical value “2” to be expanded is merely an example, and the emotion map 300 may be expanded by 3 or greater, or be expanded by 1. Additionally, a configuration is possible in which the numerical value that the emotion map 300 is expanded differs by axis or is different for the maximum value and the minimum value.

In FIG. 7, the learning of the emotion change data 122 and the expanding of the emotion map 300 are performed after the controller 110 determines that the date has changed in step S110, but a configuration is possible in which the learning of the emotion change data 122 and the expanding of the emotion map 300 are performed after a determination is made that a reference time (for example, 9:00 PM) has arrived. Moreover, a configuration is possible in which the determination in step S110 is not a determination based on the actual date, but is a determination performed on the basis of a value obtained by accumulating, by the timer function of the controller 110, an amount of time that the robot 200 has been turned ON. For example, a configuration is possible in which every time a cumulative amount of time that the power is ON is an amount of time that is a multiple of 24, the robot 200 is regarded as having grown one day, and the learning of the emotion change data 122 and the expanding of the emotion map 300 are carried out.

Next, the controller 110 adds 1 to the growth days count data 123 (step S114), initializes both the X value and the Y value of the emotion data 121 to 0 (step S115), and executes step S102. Note that, when it is desirable that the robot 200 carries over the pseudo-emotion of the previous day to the next day, the controller 110 executes step S102 without executing the processing of step S115.

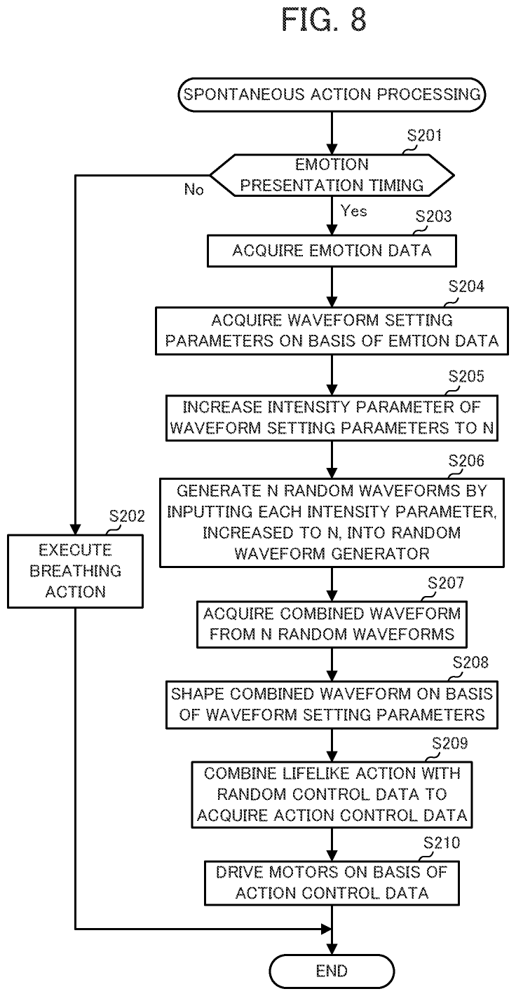

Next, the spontaneous action processing that is executed in step S109 of the action control processing is described while referencing FIG. 8.

Firstly, the controller 110 determines whether a current timing is an emotion presentation timing (step S201). How the emotion presentation timing is set may be determined as desired and, in the present embodiment, it is assumed that the determination of step S201 is “Yes” for every emotion presentation cycle (for example, three minutes).

In step S201, when a determination is made that it is not the emotion presentation timing (step S201; No), the controller 110 executes the breathing action (step S202), and ends the spontaneous action processing. Note that the specific control content of the breathing action is stored in advance (in the same manner as the motion data stored in the control content table 124) in the storage 120 as sequence data for controlling the driver 220 such that the robot 200 appears to be breathing.

When a determination is made that it is the emotion presentation timing (step S201; Yes), the controller 110 acquires the emotion data 121 (step S203). Then, the controller 110 acquires, on the basis of the emotion data 121, waveform setting parameters for waveform generation (step S204).

The waveform setting parameters are parameters for setting a waveform (waveform such as that illustrated as the motion data in FIG. 6) that indicates how the rotational angle (left-right angle) of the twist motor 221 and the rotational angle (up-down angle) of the vertical motor 222 change in accordance with the amount of time (step). That is, in the waveform setting parameters, there is an up-down waveform setting parameter for setting the waveform of the up-down angle, and a left-right waveform setting parameter for setting the waveform of the left-right angle. Additionally, in the present embodiment, in addition to these waveform setting parameters, there are specific action parameters that express whether to perform a lifelike action presented in accordance with the emotion.

The up-down waveform setting parameter and the left-right waveform setting parameter each have parameters that set an irregularity (N) of the waveform, an intensity of the waveform (intensity parameter), and an amplitude of the waveform (amplitude parameter). The up-down waveform setting parameter has an offset parameter for setting an offset of the waveform.

N, which is the parameter that sets the irregularity of the waveform, is a parameter for determining how many random waveforms to generate by the random waveform generator that uses Perlin noise. The frequency of the random waveforms generated using Perlin noise is constant but, in the present embodiment, the controller 110 generates N random waveforms having different frequencies, and combines (simply adds) the N random waveforms to acquire a random waveform in which not only the amplitude, but also the frequency randomly changes. The value of N can be determined as desired. In one example, the controller 110 acquires 5 as N. As the value of N increases, the irregularity of the random waveforms to be generated also increases.

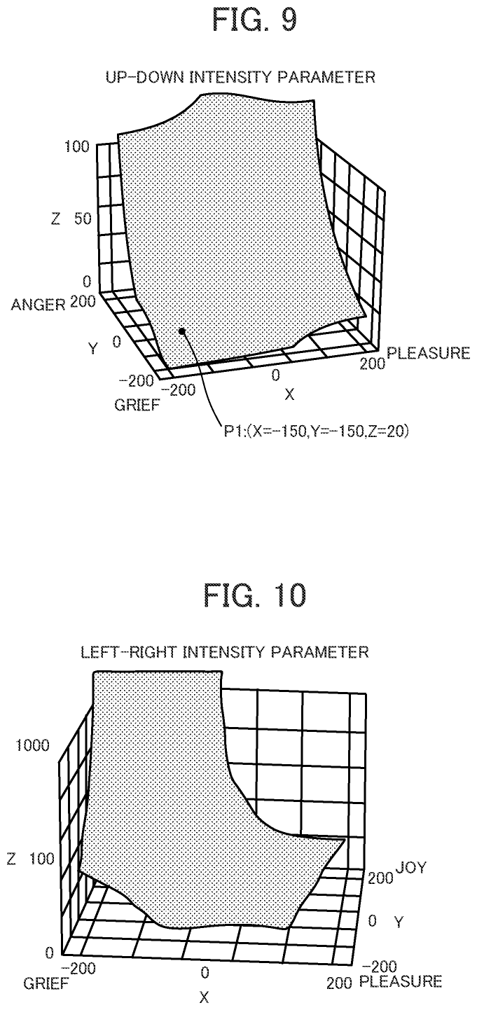

The intensity parameter that sets the intensity of the waveform is an input parameter of the random waveform generator, and sets the frequency when generating the random waveforms using Perlin noise. As illustrated in the up-down waveform 3D (dimension) map of FIG. 9 and the left-right waveform 3D map of FIG. 10, setting values, of the intensity parameters, corresponding to the value of the emotion data 121 are provided in advance as 3D maps. The controller 110 can acquire each of an up-down intensity parameter and a left-right intensity parameter by acquiring the various values on the 3D map corresponding to the coordinate values (X, Y) of the current emotion data 121. For example, when the current value of the emotion data 121 is (X=−150, Y=−150), that value corresponds to point P1 (X=−150, Y=−150, Z=20) of FIG. 9 and, as such, 20 is acquired as the up-down intensity parameter. Basically, the intensity parameters are such that, as illustrated in FIGS. 9 and 10, the intensity increases as the degree of excitement increases.

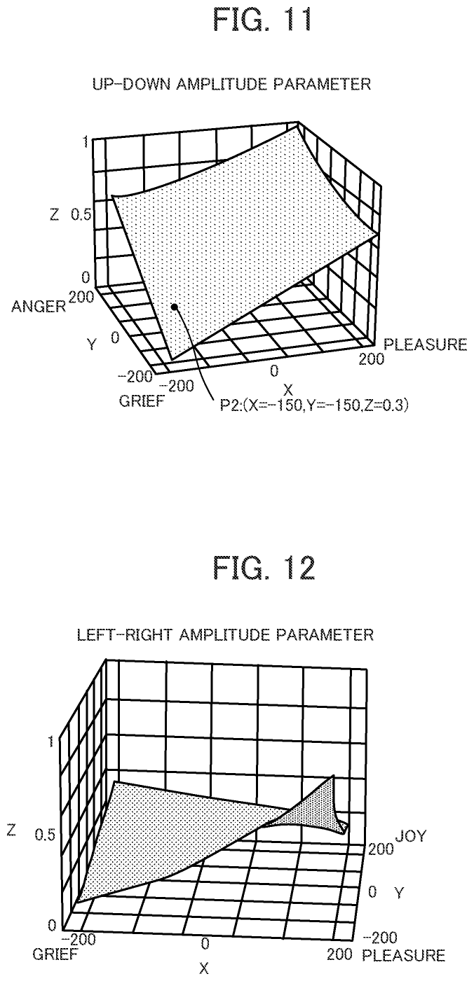

The amplitude parameter that sets the amplitude of the waveform is a parameter that sets the amplitude of the waveform obtained by combining the N random waveforms. As illustrated in the up-down waveform 3D map of FIG. 11 and the left-right waveform 3D map of FIG. 12, setting values, of the amplitude parameters, corresponding to the value of the emotion data 121 are provided in advance as 3D maps. The controller 110 can acquire each of an up-down amplitude parameter and a left-right amplitude parameter by acquiring the various values on the 3D map corresponding to the coordinate values (X, Y) of the current emotion data 121. For example, when the current value of the emotion data 121 is (X=−150, Y=−150), that value corresponds to point P2 (X=−150, Y=−150, Z=0.3) of FIG. 11 and, as such, 0.3 is acquired as the up-down amplitude parameter. Basically, the amplitude parameters are set such that, as illustrated in FIG. 11, the up-down amplitude increases as the emotion of joy increases and, as illustrated in FIG. 12, the left-right amplitude increases as the emotion of peace increases.

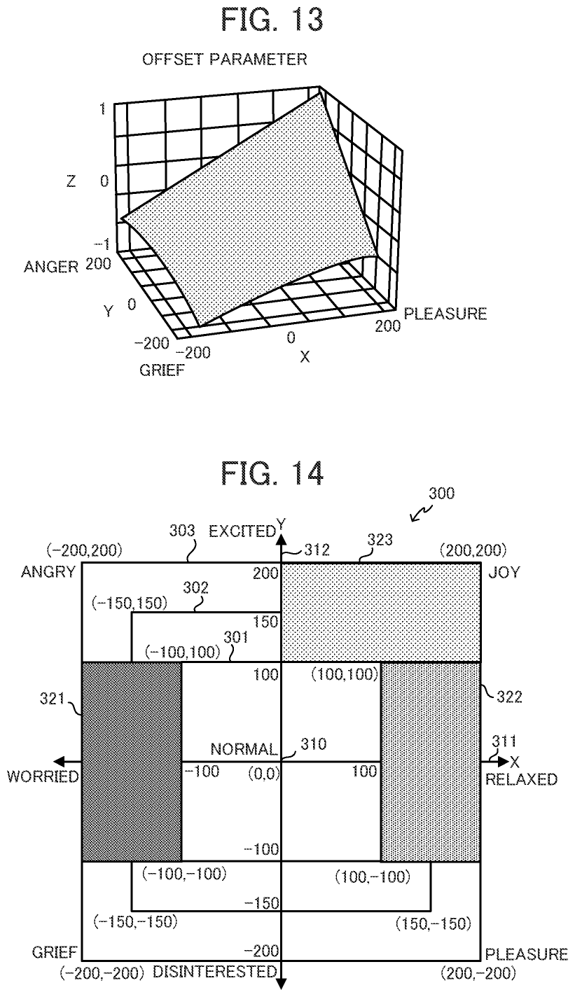

The offset parameter that sets the offset of the waveform is a parameter that adjusts the position of the origin of the waveform obtained by combining the N random waveforms. The offset parameter is a parameter for facing the head 204 upward when the emotion is chipper, for example, and for directing the head 204 downward when the emotion is sad. Accordingly, there is only an up-down waveform offset parameter, and there is no left-right waveform offset parameter. As illustrated in the 3D map of FIG. 13, a setting value, of the offset parameter, corresponding to the value of the emotion data 121 is provided in advance as a 3D map. The controller 110 can acquire the offset parameter by acquiring the values on the 3D map corresponding to the coordinate values (X, Y) of the current emotion data 121. Basically, the offset parameter is set such that, as illustrated in FIG. 13, the offset increases as the emotion of joy increases.

The specific action parameters are flags indicating whether to perform a lifelike action presented in accordance with the emotion. In the present embodiment, three flags, namely a trembling action generating flag, a grooming action generating flag, and a gratification action generating flag are specific action parameters. The specific action parameters are flag variables that are set to 1 (ON) when the range of the value of the emotion data 121 is included in a specific range, and to 0 (OFF) at other times. Specifically, in the emotion map 300 illustrated in FIG. 14, when the value of the emotion data 121 is included in a region 321, the trembling action generating flag is set to 1, when included in a region 322, the grooming action generating flag is set to 1, and when included in a region 323, the gratification action generating flag is set to 1. Returning to FIG. 8, the controller 110 that has acquired the setting parameters in step S204 increases the acquired intensity parameter to N (step S205). Specifically, the controller 110 increases the intensity parameter to N intensity parameters by fluctuating the value of the intensity parameter acquired in step S204 by a factor of 1 to 2 with a random number. Next, the controller 110 generates N random waveforms by inputting each of the intensity parameters, increased to N in step S205, into the random waveform generator (step S206). In this case, it is assumed that each random waveform generates a waveform having a length corresponding to 100 steps (10 seconds). Then, the controller 110 acquires a combined waveform by simply adding the N random waveforms (steps S207).

Next, the controller 110 shapes the combined waveform acquired in step S207 on the basis of the waveform setting parameters acquired in step S204 (step S208). More specifically, the controller 110 adjusts the amplitude of the combined waveform on the basis of the amplitude parameters, adjusts the position in the up-down direction of the origin of the combined waveform of the basis of the offset parameter, and performs processing for smoothly returning a value of a waveform edge to 0.

Specifically, as the adjustment based on the amplitude parameters, the controller 110 multiplies the value of the combined waveform by the amplitude parameters. As the adjustment in the up-down direction of the position of the origin, the controller 110 adds the offset parameter to the value of the combined waveform. As the processing for smoothly returning the value of the waveform edge to 0, when, for example, the combined waveform is a waveform having from step (0) to step (100) and the value that sets the region of the waveform edge is x (for example, 10), in a step (i) from step (0) to step (x), the controller 110 multiplies a value v of the waveform by i/x to smoothly bring the waveform value of the waveform edge close to 0. Additionally, the controller 110 likewise smoothly brings the value of the waveform edge close to 0 in the region from step (100-x) to step (100).

Note that the waveform shaped by the controller 110 in step S208 is a waveform generated from the N random waveforms and is a waveform that controls the driver 220 in step S210, described later. As such, this waveform is also called a “random control waveform.” Moreover, sequence data expressed by the random control waveform is called “random control data.” Accordingly, in step S208, the controller 110 acquires the random control data by shaping the combined waveform.

Next, the controller 110 combines the lifelike action with the random control data acquired in step S208 to acquire action control data (step S209). Note that this step is executed when the flag of one of the specific action parameters is set to 1 (ON), and when all of the specific action parameters are set to 0 (OFF), the controller 110 acquires the random control data as-is as the action control data, and executes step S210. The process for combining the lifelike action is described in detail later.

Next, the controller 110 drives the twist motor 221 and the vertical motor 222 on the basis of the action control data acquired in step S209 (step S210), and ends the spontaneous action processing.

As a result of the spontaneous action processing, the robot 200 performs, on a regular basis, an action of presenting the current emotion, and the action control data for controlling this action is automatically generated from the waveform setting parameters acquired on the basis of the value of the emotion data 121. Accordingly, in the present embodiment, the setting of action control content based on a pseudo-emotion can be facilitated.

Next, three processes, namely a trembling action generating process, a grooming action generating process, and a gratification action generating process are described, in this order, as specific examples of the processes performed in step S209 of the spontaneous action processing.

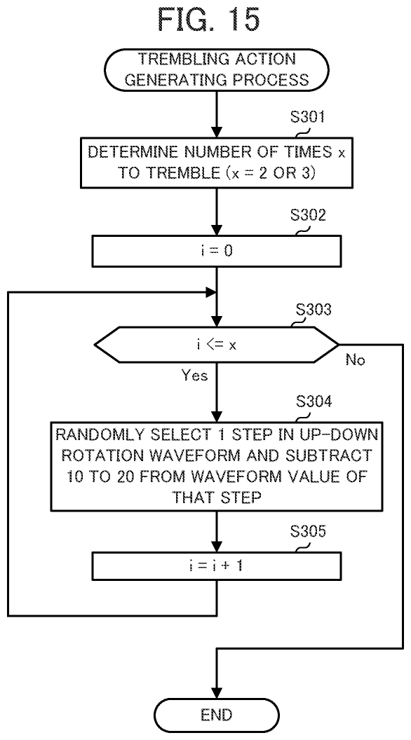

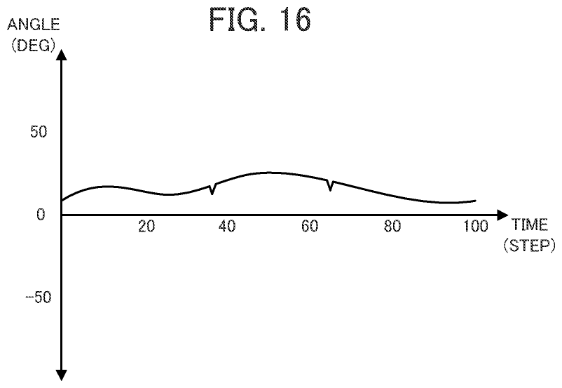

Firstly, the trembling action generating process is described while referencing FIG. 15. This action is for presenting an emotion of worry by quickly raising and lowering the head 204 in a trembling manner when the emotion of the robot 200 is in a state of “worry.”

Firstly, the controller 110 determines, by a random number, 2 or 3 as a number of times x to move the head 204 in a trembling manner (step S301). Then, the controller 110 substitutes 0 for a variable i (step S302).

Next, the controller 110 determines whether the value of i is less than or equal to x (step S303). When a determination is made that the value of i is less than or equal to x (step S303; Yes), of the random control data generated up to step S208 of the spontaneous action processing, 1 step is randomly selected in an up-down rotation waveform, a predetermined value (for example a value of from 10 to 20) is randomly subtracted from the waveform value in that step, and the result is used as the action control data (step S304). However, when the controller 110 understands that the randomly selected step duplicates a previously (at a point in time at which the value of i is 1 or 2 less) selected step, the controller 110 may reselect until a non-duplicate step is selected.

Next, the controller 110 adds 1 to the variable i (step S305), and executes step S303.

Meanwhile, when a determination is made in step S303 that the value of i is greater than x (step S303; No), the controller 110 ends the trembling action generating process.

As a result of the trembling action generating process, action control data expressed by a waveform such as that illustrated in FIG. 16, for example, is generated as up-down rotation action control data. Moreover, the robot 200 can perform an action for causing the head 204 to tremble, and can present the emotion of worry by the controller 110 driving the vertical motor 222 on the basis of the action control data expressed by this waveform. Note that, in the trembling action generating process, the controller 110 generates a trembling action only for the up-down rotation random control data, and uses the left-right rotation random control data as-is as the action control data without performing any processes thereon. As such, the twist motor 221 is driven on the basis of the random control data acquired in step S208 of the spontaneous action processing (FIG. 8).

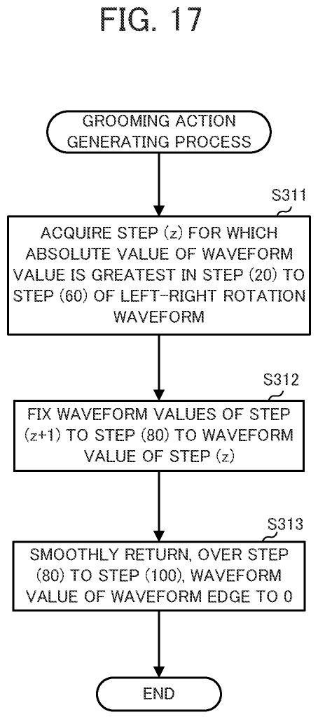

Next, the grooming action generating process is described while referencing FIG. 17. This action is for presenting an emotion of being relaxed as a result of an action resembling grooming being performed, when the emotion of the robot 200 is in a state of “relaxed.”

Firstly, of the random control data generated up to step S208 of the spontaneous action processing, the controller 110 acquires the step for which the absolute value of the waveform value is greatest among step (20) to step (60) of the left-right rotation waveform (in this case, step (z)) (step S311). Next, the controller 110 fixes the waveform values of step (z+1) to step (80) of the left-right rotation waveform to the waveform value of step (z) (step S312).

Next, the controller 110 smoothly returns the value of the waveform edge to 0 (step S313) over step (80) to step (100), sets the sequence data expressed by the obtained waveform as the action control data, and ends the grooming action generating process. Note that the processing of step S313 is the same as the processings for smoothly returning the value of the waveform edge to 0 in step S208 of the spontaneous action processing.

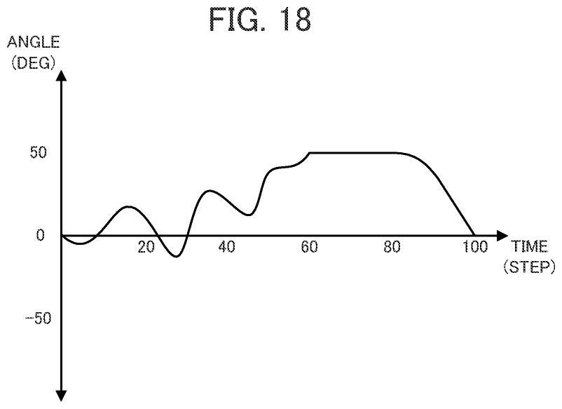

As a result of the grooming action generating process, action control data expressed by a waveform such as that illustrated in FIG. 18, for example, is generated as left-right rotation action control data. Additionally, the controller 110 does not perform any processes on the up-down rotation random control data, and uses the up-down rotation random control data as-is as the up-down rotation action control data. Accordingly, the controller 110 drives the twist motor 221 and the vertical motor 222 on the basis of this action control data and, as a result, the robot 200 randomly moves the head 204 up and down while fixing the head 204 as much as possible in a twisted state. As a result, the robot 200 can give an impression of being relaxed and grooming.

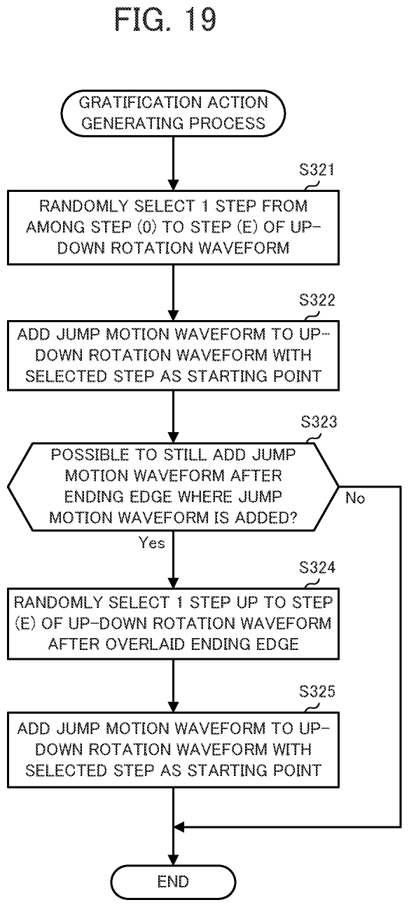

Next, the gratification action generating process is described while referencing FIG. 19. This action is for presenting joy by performing an action such as jumping, when the emotion of the robot 200 is in a state of “joy.”

Firstly, of the random control data generated up to step S208 of the spontaneous action processing, the controller 110 randomly selects 1 step from among step (0) to step (E) of the up-down rotation waveform (step S321). Note that the value of E of step (E) is described later.

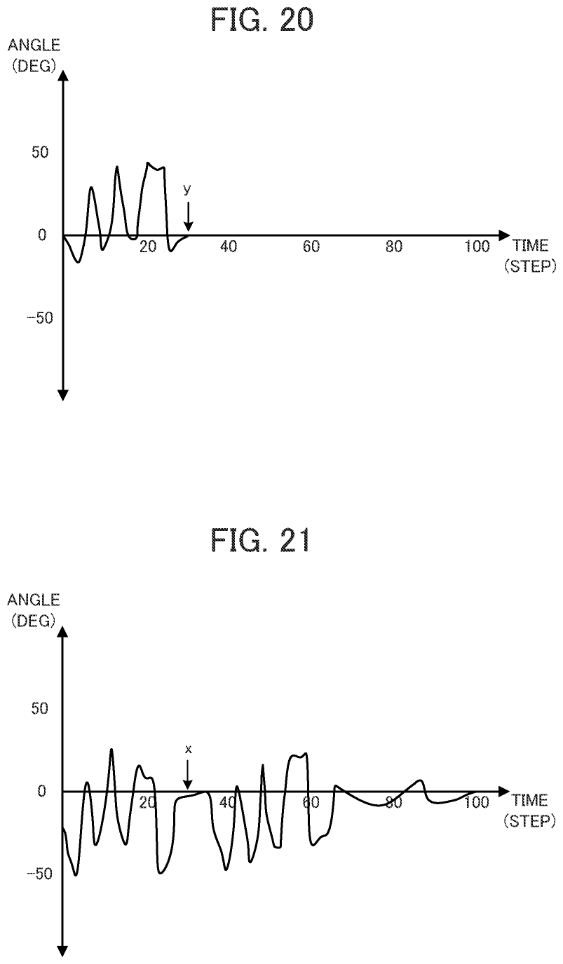

Next, with the selected step as a starting point, the controller 110 overlays and adds a jump motion waveform to the up-down rotation waveform (step S322). The jump motion waveform is a waveform in which up-down rotation sequence data, for driving the vertical motor 222 and causing the robot 200 to perform a jumping motion, is expressed as a waveform, and is a waveform such as that illustrated in FIG. 20, for example. The length of the jump motion waveform can be set as desired. In this case, the jump motion waveform has a length corresponding to 30 steps. The value of E is obtained by subtracting the length of the jump motion waveform (for example, 30 steps) from the length of the random waveform (for example, 100 steps). In the present embodiment, the value of E is 70.

Next, the controller 110 determines whether it is possible to still add a jump motion waveform after the ending edge where the jump motion waveform is overlaid and added to the up-down rotation waveform of the random control data (step S323). Specifically, when the ending edge where the jump motion waveform is overlaid and added is (as illustrated in FIG. 21) step (x), and the ending edge of the jump motion waveform is (as illustrated in FIG. 20) step (y), when (100−x)≥y, the controller 110 determines that adding of the jump motion waveform is possible.

When a determination is made that adding of the jump motion waveform is possible (step S323; Yes), the controller 110 randomly selects 1 step from among the steps from the ending step (step (x)) added in step S322 to step (E) of the up-down rotation waveform (step S324). Then, with the selected step as the starting point, the controller 110 adds the jump motion waveform to the up-down rotation waveform (step S325), sets the sequence data expressed by the obtained waveform as the action control data, and ends the gratification action generating process.

Meanwhile, when a determination is made in step S323 that adding of the jump motion waveform is not possible (step S323; No), the controller 110 sets the sequence data expressed by the waveform obtained to that point as the action control data, and ends the gratification action generating process.

As a result of the gratification action generating process, action control data expressed by a waveform such as that illustrated in FIG. 21, for example, is generated as the up-down rotation action control data. Moreover, the robot 200 can perform an action such as jumping, and can present the emotion of joy by the controller 110 driving the vertical motor 222 on the basis of the action control data expressed by this waveform. Note that, in the gratification action generating process, the controller 110 generates a jump motion waveform only for the up-down rotation random control data, and uses the left-right rotation random control data as-is as the action control data without performing any processes thereon. As such, the twist motor 221 is driven on the basis of the random control data acquired in step S208 of the spontaneous action processing (FIG. 8).

Three combining processes (the trembling action generating process, the grooming action generating process, and the gratification action generating process) are described above as examples of generating a lifelike action, but these combining processes are merely examples, and other lifelike actions may be combined with the random control data. By combining the lifelike action with the random control data acquired in step S208 of the spontaneous action processing, it is possible to combine a lifelike action set in advance with an emotion expression generated from the emotion data 121, and the pseudo-emotions of the robot 200 can be presented to the user in an easier-to-understand manner.

Note that the jump motion waveform described above is a waveform that is set in advance in correspondence with the pseudo-emotion of joy of the robot 200, and is a waveform that is combined with the random control waveform and controls the driver 220 in the gratification action generating process. As such, the jump motion waveform is also called a “set control waveform.” Moreover, sequence data expressed by the set control waveform is also called “set control data.” Additionally, the processing of step S304 (processing of subtracting from 10 to 20 from the value of the waveform) of the trembling action generating process, and the processing of steps S312 and S313 (processing of fixing the value of the waveforms for a predetermined period and then returning the value to 0) of the grooming action generating process are processings that are set in advance in order to generate the action control data. As such, these processing can be thought of as a type of the set control data.

The random control waveform that the controller 110 generates in the spontaneous action processing is generated by combining the random waveform generated using Perlin noise on the basis of the input parameter corresponding to the pseudo-emotion of the robot 200. As such, the random control waveform is a smooth waveform that corresponds to the emotions of the robot 200. Accordingly, the controller 110 can generate smooth motion data that corresponds to the emotions of the robot 200. Additionally, the controller 110 controls the robot 200 using the random control waveform and, as such, can prevent the actions of the robot 200 from becoming monotonous. Moreover, aside from generating the random control waveform by combining the random waveforms, the random control waveform may be generated by referencing a random waveform to modify a desired waveform, or by filtering a desired waveform by a random waveform. Doing such leads to an advantage of there being cases in which the processing load is lighter compared to when generating by combining.

How the random control data is used is not limited to combining with the set control data. For example, the random control data may be referenced to modify the set control data, or the set control data may be filtered by the random control data. The actions of the robot 200 can be further diversified by introducing such variation into how the random control data is used.

In Embodiment 1, the combining of the random waveforms generated on the basis of the emotion data 121 is performed only for actions that are performed on a regular basis in the spontaneous action processing, and the random waveforms are not combined for actions based on external stimuli. As such, the robot 200 executes each of actions using the random waveforms (executed on a regular basis), and actions set by the control content table 124 (executed in accordance with external stimuli) and, as such, the user can compare and enjoy the differences and the like between the actions and can enjoy more lifelike actions in the spontaneous action processing.

### Embodiment 2

In Embodiment 1, in the spontaneous action processing, the controller 110 generates (and combines) a random control waveform expressing an emotion and, as such, can cause the robot 200 to present emotions on a regular basis. However, a configuration is possible in which the generation and combining of the random control waveform that expresses an emotion is performed outside of the spontaneous action processing. Here, Embodiment 2, in which the random control waveform that expresses an emotion is generated and combined in an action performed when an external stimulus is received, is described.

The functional configuration and the structure of the robot 200 according to Embodiment 2 are the same as in Embodiment 1 and, as such, description thereof is omitted. However, in the action control processing (FIG. 7) according to Embodiment 2, the processing of step S107 is replaced with a hereinafter described emotional action generating process. The emotional action generating process is a process in which, as in the spontaneous action processing (FIG. 8), the controller 110 generates a random control waveform for presenting an emotion, combines this random control waveform with original motion data and, then, controls the driver 220. Note that the original motion data is motion data that is set in advance in the control content table 124, and is a type of the set control data.

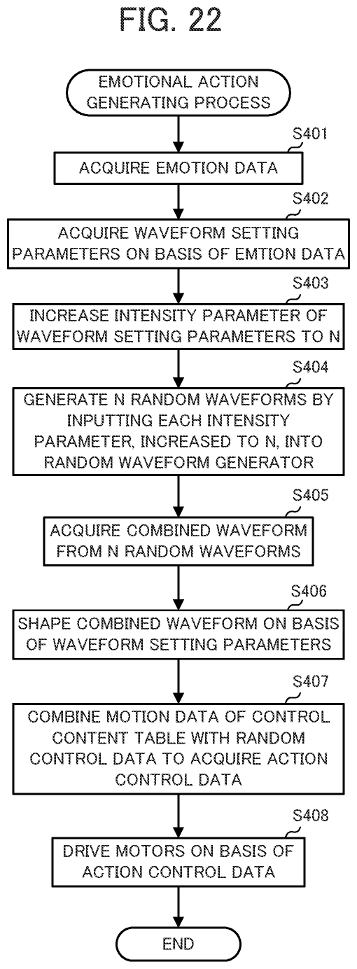

The emotional action generating process is described while referencing FIG. 22. However, since much of the process is shared with the spontaneous action processing (FIG. 8), the description is focused on the main differing points.

Firstly, the processing of step S401 to step S406 of the emotional action generating process is the same as the processing of step S203 to step S208 of the spontaneous action processing and, as such, description thereof is forgone.

In step S407, the controller 110 combines, by simple addition, the control data (motion data included in the control content table 124) acquired in step S106 of the action control processing (FIG. 7) with the random control data acquired in step S406 to acquire the action control data.

Next, the controller 110 drives the twist motor 221 and the vertical motor 222 on the basis of the action control data acquired in step S407 (step S408), ends the emotional action generating process, and executes step S110 of the action control processing (FIG. 7).

As a result of the emotional action generating process described above, the controller 110 combines the random control data that reflects the value of the emotion data 121 with the control data of the control content table 124 and, as a result, can cause the robot 200 to perform motion that corresponds to the pseudo-emotion of the robot 200. Accordingly, even when the content of the control data of the control content table 124 does not change on the basis of the emotion data 121, the controller 110 can cause the robot 200 to perform motion that corresponds to the emotion of the robot 200.

The random control data that the controller 110 generates is generated by combining the random waveforms generated using Perlin noise. As such, the controller 110 can generate action control data that causes smooth motion to be performed in accordance with the emotion of the robot 200. Additionally, since the random control waveform to be combined is a random waveform, the action control data that is generated as a result of the combining changes every time, and the actions of the robot 200 can be prevented from becoming monotonous.

### Embodiment 3

In the embodiments described above, the action control data is generated by simply adding the set control data that is set in advance (the motion data of the control content table 124, the data expressed by the jump motion waveform in the gratification action generating process, and the like) and the random control data generated using the random waveform generator. However, the combining of the set control data and the random control data when generating the action control data is not limited to simple addition.

Here, Embodiment 3, in which weighting (a combining ratio) of the random control data when generating the action control data is lowered in accordance with increases in a pseudo-growth days count of the robot 200, is described.

The functional configuration and the structure of the robot 200 according to Embodiment 3 are the same as in Embodiment 2 and, as such, description thereof is omitted. However, in step S407 of the emotional action generating process (FIG. 22) according to Embodiment 3, the controller 110 acquires the action control data by weighted addition instead of by simple addition.

The method of setting the weighting when using weighted addition may be determined as desired but, in the present embodiment, the controller 110 increases the weighting of the set control data and decreases the weighting of the random control data as the value of the growth days count data 123 increases.

Specifically, in one example, when the weighting of the set control data is A, the weighting of the random control data is B, and the growth days count data 123 is D, the weightings are set as follows.

If D≤3, A=D×10(%) and B=(10−D)×10(%)

If D≤15, A=22.5+D×2.5(%) and B=77.5−D×2.5(%)

If D≥31, A=100(%) and B=0(%)

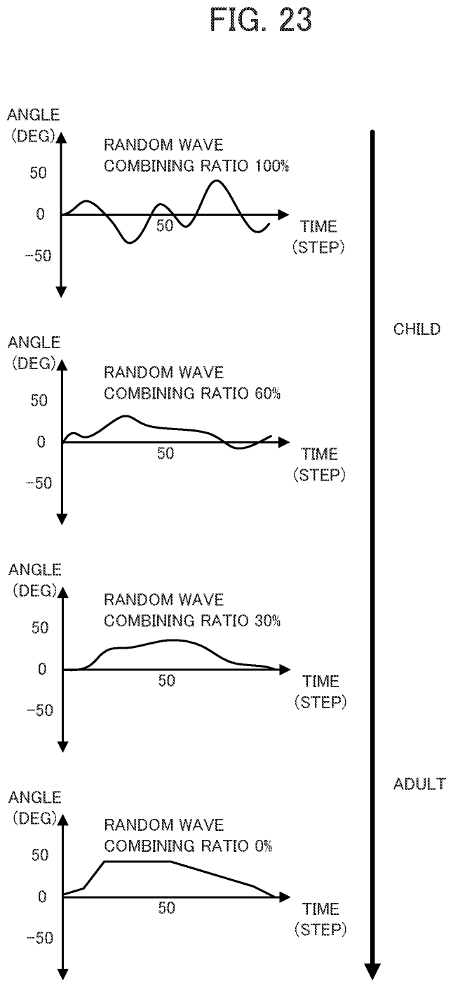

As a result of combining the set control data and the random control data by weighted addition, as illustrated in FIG. 23, for example, the combining ratio of the random waveform in the action control data that controls the actions of the robot 200 decreases (for example, from 100% to 0%) as the robot 200 grows from child (when the growth days count data 123 is less than or equal to a child threshold (for example, 7)) to adult (when the growth days count data 123 is greater than or equal to an adult threshold (for example, 30)).

Accordingly, randomness decreases and actions become efficient due to the pseudo-growth of the robot 200, and the robot 200 performs refined motions such as commonly displayed by an adult. Conversely, the combining ratio of the random waveform increases as the robot 200 is younger and, as such, although smooth, wasted movement increases and the robot 200 performs motions giving the impression of being distracted, such as are normally displayed by a child.

A configuration is possible in which, instead of weighted addition, the controller 110 multiplies the set control data by the random control data. Specifically, when a value obtained by normalizing the value of the set control data to a range from −90 to 90 is f(t), and a value obtained by normalizing the value of the random control data to a range from 0 to 2 is g(t), the value of f(t)×g(t) is set as the value of the action control data.

In such a case, when increasing the weighting of the random control data (when the robot 200 is young), the value of the random control data is varied in the range of 0 to 2 and, when decreasing the weighting (as the growth days count data 123 increases), the value of the random control data is varied near 1. In one example, when the weighting of the random control data is B (%), the controller 110 normalizes the value of the random control data so as to be in a range of 1−B/100 to 1+B/100, and then multiplies the normalized value by the set control data to generate the action control data.

In this case as well, randomness decreases due to the pseudo-growth of the robot 200, and the robot 200 performs motions close to the set actions. As the robot 200 is younger, the randomness increases and the robot 200 performs motions that do not reflect the set action very much.

A configuration is possible in which the controller 110 changes not only the motion data of the control data of the control content table 124, but also the sound effect data in accordance with the growth days count data 123. For example, a configuration is possible in which, when the growth days count data 123 is less than or equal to the child threshold, a high animal sound is output by raising the pitch of the sound effect data of the control content table 124 and then outputting, and when the growth days count data 123 is greater than or equal to the adult threshold, a low animal sound is output by lowering the pitch of the sound effect data of the control content table 124 and then outputting. Additionally, a configuration is possible in which the pitch of the output animal sound is lowered as the growth days count data 123 increases, regardless of the child threshold and/or the adult threshold.

As described above, in Embodiment 3, the randomness of the motion and/or the pitch of the animal sound changes in accordance with the growth days count data 123 and, as such, the robot 200 can express growth by the randomness of motion and/or the animal sound.

### MODIFIED EXAMPLES

The present disclosure is not limited to the embodiments described above, and various modifications and uses are possible. For example, in Embodiment 2, a configuration is possible in which the breathing action is always performed in the spontaneous action processing (emotion presentation is not performed), and the presentation of emotion is performed only in the emotional action generating process (FIG. 22).

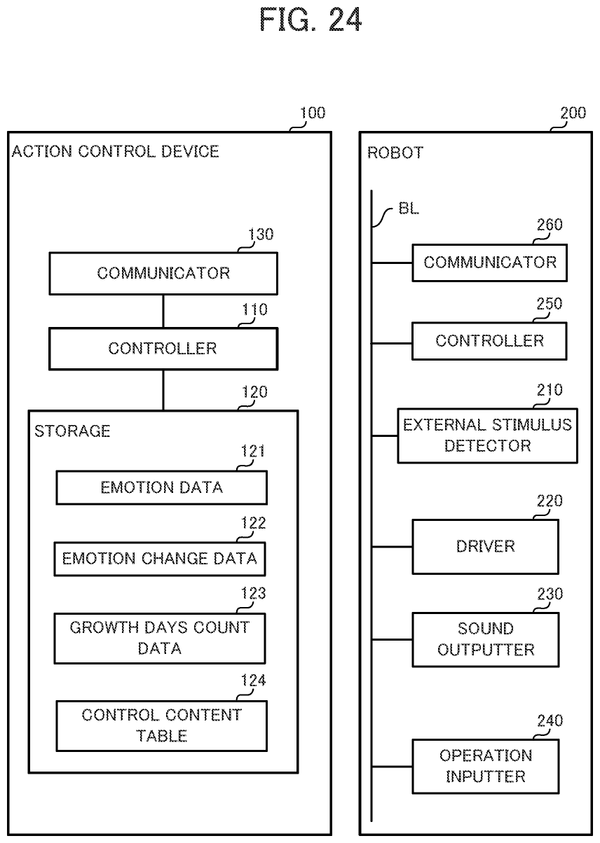

In the embodiments described above, a configuration is described in which the action control device 100 is built into the robot 200, but a configuration is possible in which action control device 100 is not built into the robot 200. For example, as illustrated in FIG. 24, a configuration is possible in which an action control device 100 according to a modified example is configured as a device (for example, a server) separate from the robot 200, the action control device 100 includes a communicator 130, and the robot 200 also includes a controller 250 and a communicator 260. In such a case, the communicator 130 and the communicator 260 are configured so as to send and receive data to and from each other, and the controller 110 acquires the external stimulus detected by the external stimulus detector 210, controls the driver 220 and the sound outputter 230, and the like via the communicator 130 and the communicator 260.

In the embodiments described above, a description is given in which the action programs executed by the CPU of the controller 110 are stored in advance in the ROM or the like of the storage 120. However, the present disclosure is not limited thereto, and a configuration is possible in which the action programs for executing the various processings described above are installed on an existing general-purpose computer or the like, thereby causing that computer to function as a device corresponding to the action control device 100 according to the embodiments described above.

Any method can be used to provide such programs. For example, the programs may be stored and distributed on a non-transitory computer-readable recording medium (flexible disc, Compact Disc (CD)-ROM, Digital Versatile Disc (DVD)-ROM, Magneto Optical (MO) disc, memory card, USB memory, or the like), or may be provided by storing the programs in a storage on a network such as the internet, and causing these programs to be downloaded.

Additionally, in cases in which the processings described above are realized by being divided between an operating system (OS) and an application/program, or are realized by cooperation between an OS and an application/program, it is possible to store only the portion of the application/program on the non-transitory recording medium or in the storage. Additionally, the programs can be piggybacked on carrier waves and distributed via a network. For example, the programs may be posted to a bulletin board system (BBS) on a network, and distributed via the network. Moreover, a configuration is possible in which the processings described above are executed by starting these programs and, under the control of the operating system (OS), executing the programs in the same manner as other applications/programs.

Additionally, a configuration is possible in which the controller 110 is constituted by a desired processor unit such as a single processor, a multiprocessor, a multi-core processor, or the like, or by combining these desired processors with processing circuitry such as an application specific integrated circuit (ASIC), a field-programmable gate array (FPGA), or the like.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

1. An action control device comprising:
a controller that controls an action of a controlled device, wherein
the controller
controls the action of the controlled device using set control data that is set in advance in correspondence with a pseudo-emotion and random control data that is randomly generated in accordance with the pseudo-emotion.

2. The action control device according to claim 1, wherein
the controller
generates action control data by combining the set control data set in advance and the random control data that is randomly generated in accordance with the pseudo-emotion, and
controls the action of the controlled device using the action control data.

3. The action control device according to claim 1, wherein
the controller sets, based on the pseudo-emotion, a setting parameter for generating the random control data.

4. The action control device according to claim 3, wherein
the controller
stores, in a storage, a 3D map that associates the pseudo-emotion and the setting parameter, and
acquires and sets the setting parameter by the 3D map.

5. The action control device according to claim 2, wherein
the controller changes, in accordance with a pseudo growth days count, at least one of a combining ratio of the set control data and a combining ratio of the random control data.

6. The action control device according to claim 1, wherein
the controller further
acquires an external stimulus acting on the controlled device, and
changes the pseudo-emotion in accordance with the acquired external stimulus.

7. The action control device according to claim 1, wherein
the set control data includes control data that controls an action that the controlled device executes on a regular basis.

8. The action control device according to claim 1, wherein
the controller generates the random control data using Perlin noise.

9. An action control method comprising:
controlling, by a controller of an action control device that controls an action of a controlled device, the action of the controlled device using set control data that is set in advance in correspondence with a pseudo-emotion and random control data that is randomly generated in accordance with the pseudo-emotion.

10. A non-transitory computer-readable recording medium storing a program that causes a computer, of an action control device that controls an action of a controlled device, to:
control the action of the controlled device using set control data that is set in advance in correspondence with a pseudo-emotion and random control data that is randomly generated in accordance with the pseudo-emotion.
